(19) United States
(12) Patent Application Publication
(10) Pub. No.: US 2004/0052547 A1
(43) Pub. Date: Mar. 18, 2004

(54) Image forming apparatus and process cartridge used in the same

(75) Inventors: Tomoyuki Matsuura, Saitama (JP); Manabu Saito, Saitama (JP); Hidekazu Amamoto, Saitama (JP); Atsuna Saiki, Saitama (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/367,881

(22) Filed: Feb. 19, 2003

(30) Foreign Application Priority Data
Sep. 17, 2002 (JP) P2002-270050

(51) Int. Cl. G03G 15/00; G03G 15/04

(52) U.S. Cl. 399/119; 399/405

(57) ABSTRACT

A recording medium printed out by an image forming section 14 is ejected to an ejection unit 16 provided at an upper portion of an image forming apparatus 10. This ejection unit 16 owns an inclination portion 52 which is obliquely formed and has both a lower edge and an upper edge. At least a portion of a developer storage space 70 is arranged in an area “A” which is surrounded by this inclination portion 52, a horizontal plane extended from the lower edge of the inclination portion 52, and also, a vertical plane extended from the upper edge of the inclination portion 52.

### BACKGROUND OF THE INVENTION

1. Field of the Invention

The present invention is related to an electro-photographic type, or other types of image forming apparatus, and a process cartridge employed in this image forming apparatus.

2. Description of the Related Art

As this sort of image forming apparatus, such an image forming apparatus is known in which while a recording medium is transported along a substantially vertical direction, an image is formed on this transported recording medium, and then, the recording medium on which the image has been formed is ejected to an ejection unit provided on an upper portion of a main body of this image forming apparatus as disclosed in JP-A-10-207160.

As previously explained, in such a type of image forming apparatus that the recording medium is transported along the vertical direction, a dead space may be readily formed at a lower portion of the ejection unit. In other words, for instance, in an electro-photographic type image forming apparatus, a developing apparatus is arranged under a vertical transport path, and also, a fixing apparatus is arranged above the vertical transport path, respectively. As a result, a lower portion of an ejection unit, which is extended from the fixing apparatus to a side direction while being inclined, may constitute a dead space.

### SUMMARY OF THE INVENTION

An object of the present invention is to effectively utilize a space just under the inclination portion of the ejection unit, where the dead space may be easily produced.

To achieve an object, a first feature of the present invention is such an image forming apparatus includes an image forming section having a developer storage space into which developer is stored, and an ejection unit for ejecting therefrom a recording medium on which an image has been formed by the image forming section, in which the ejection unit owns an inclination portion which has a lower end and an upper end, while being obliquely formed, and at least a portion of the developer storage space of the image forming section is arranged in an area which is surrounded by the inclination portion, a horizontal plane extended from the lower end of the inclination portion, and a vertical plane extended from the upper end of the inclination portion. As a consequence, since the developer storage space is arranged in the area which is surrounded by the inclination portion, the horizontal plane extended from the lower end, and the vertical plane extended from the upper end, a lower portion of the inclination portion of the ejection unit can be utilized as the developer storage space.

A second feature of the present invention is such an image forming apparatus includes an image forming section having a developer storage space into which developer is stored, and an ejection unit for ejecting therefrom a recording medium on which an image is formed by the image forming section, in which the ejection unit owns an inclination portion which is obliquely formed, and at least a portion of a wall surface which surrounds the developer storage space along the inclination portion is formed. As a result, since the wall surface of the developer storage space is formed along the inclination portion, the lower portion of the inclination portion of the ejection unit can be similarly utilized as the developer storage space.

The image forming section is not limited only to an ink jet type image forming section, but also not to an electro-photographic type image forming section. However, the electro-photographic type image forming section is preferably employed. In the case of such an electro-photographic image forming system, the image forming section may be arranged by employing an image carrier on which is a latent image is formed; the developer storage space owns a first developer storage portion arranged at an upper portion thereof, and a second developer storage portion arranged at a lower portion thereof, while sandwiching therebetween a horizontal line which is extended from a latent image forming position of the image carrier along a horizontal direction; and the first developer storage portion is connected to the second developer storage portion. Preferably, a developer storage capacity of the first developer storage portion is larger than that of the second developer storage portion.

It should be noted that in the case of the electro-photographic type image forming system, the developer is a toner, or such a mixture made of a toner and a carrier. In the case of the ink jet type image forming system, the developer is ink, and then, a portion of an ink tank is arranged at the lower portion of the ejection unit.

Also, in the case of the electro-photographic type image forming system, the image carrier is a photosensitive member, and an optical writing apparatus for forming a latent image on the image carrier is employed. Furthermore, the optical writing apparatus is constituted by a laser exposing apparatus, and may be arranged at a position which is extended from the latent image forming position of the image carrier to the horizontal direction.

Further, the image forming section may be preferably provided with a process cartridge which includes an image carrier on which a latent image is formed, and a developing unit containing the developer storage, for developing the latent image of the image carrier so as to produce a visible image. This process cartridge may be dismounted and mounted from the upper portion of the apparatus main body by opening/closing the inclination portion. In order to easily detachably mount this process cartridge, a grip portion is provided on a portion of a wall surface which constitutes the developer storage space, and then, the process cartridge may be detachably mounted by handling this grip portion.

Also, a third feature of the present invention is such a process cartridge used in an image forming apparatus containing an ejection unit having an inclination portion which is obliquely formed in order to eject therefrom a recording medium includes a developer storage space for storing thereinto developer, in which at least a portion of the developer storage space is arranged in a space which is surrounded by the inclination portion, a horizontal plane extended from a lower end of the inclination portion, and also, a vertical plane extended from an upper end of the inclination portion.

In addition, a fourth feature of the present invention is such a process cartridge used in an image forming apparatus containing an ejection unit having an inclination portion which is obliquely formed in order to eject therefrom a recording medium includes a developer storage space for storing thereinto developer; in which at least a portion of a wall surface which surrounds the developer storage space is formed along the inclination portion.

It should also be understood that in the present invention, a process cartridge implies such a cartridge having an image carrier on which a latent image is formed, and the developing unit containing the developer storage space and for developing the latent image of the image carrier so as to produce the visible image, and which is freely detachably mounted with respect to the main body of the image forming apparatus. This process cartridge may contain such components as the cleaning apparatus and the charging apparatus.

### BRIEF DESCRIPTION OF THE DRAWINGS

FIG. 1 is a sectional view for indicating an image forming apparatus according to an embodiment mode of the present invention.

FIG. 2 is a sectional view for representing a process cartridge employed in the image forming apparatus according to an embodiment mode of the present invention.

FIG. 3 is a side view for showing a supply path of developer in the process cartridge employed in the image forming apparatus according to the embodiment mode of the present invention.

FIG. 4 is a perspective view for indicating the process cartridge employed in the image forming apparatus according to the embodiment mode of the present invention.

FIG. 5 is an exploded perspective view for indicating an image carrier unit of the process cartridge employed in the image forming apparatus according to the embodiment mode of the present invention.

FIG. 6 is an exploded perspective view for representing a developing appliance unit of the process cartridge employed in the image forming apparatus according to the embodiment mode of the present invention.

FIG. 7 is a perspective view for showing the developing apparatus unit of the process cartridge employed in the image forming apparatus according to the embodiment mode of the present invention.

FIG. 8 is an exploded perspective view of the developing apparatus unit of the process cartridge employed in the image forming apparatus according to the embodiment mode of the present invention, as viewed from a rear surface of the developing appliance unit.

### DETAILED DESCRIPTION OF THE PREFERRED EMBODIMENTS

Referring now to drawings, embodiment modes of the present invention will be described.

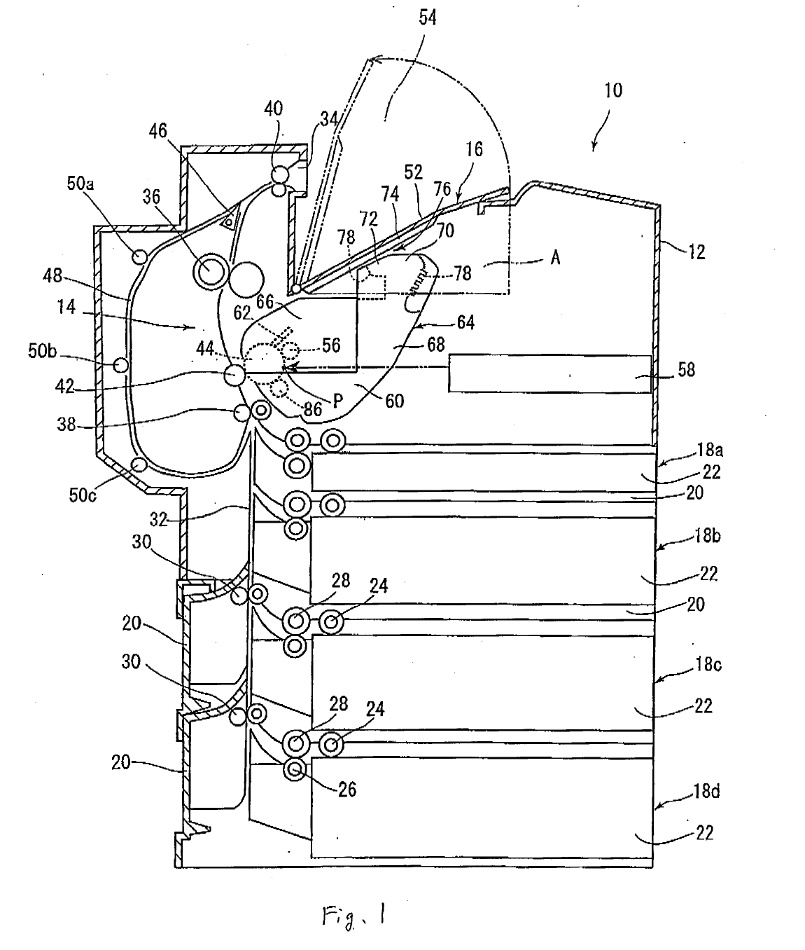

FIG. 1 schematically shows an image forming apparatus 10 according to an embodiment mode of the present invention. The image forming apparatus 10 contains a main body 12 of the image forming apparatus. An image forming section 14 is mounted on this image forming apparatus main body 12. An ejection unit 16 (will be explained later) is provided at an upper portion of this image forming apparatus main body 12, and also, for instance, two stages of paper supply units 18a and 18b are arranged at a lower portion of this image forming apparatus main body 12. Furthermore, two stages of paper supply units 18c and 18d are arranged below the image forming apparatus main body 12, while these paper supply units 18c and 18d are detachably mounted thereon as an optical paper supply unit.

Each of the paper supply units 18a to 18d owns a paper supply unit main body 20 and a paper supply cassette 22 into which paper is stored. The paper supply cassette 22 is slidably mounted with respect to the paper supply unit main body 20, and is drawn out from this paper supply unit main body 20 along a front plane direction (namely, right direction of FIG. 1). Also, a paper supply roller 24 is arranged at an upper portion near an inner end of the paper supply cassette 22, and both a retard roller 26 and a nudger roller 28 are arranged in front of this paper supply roller 24. Furthermore, feed rollers 30 are provided with the optionally-provided paper supply units 18c and 18d, and these feed rollers 30 may constitute a pair of feed rollers.

A transport path 32 corresponds to a paper path defined from the feed roller 30 of the lowermost paper supply unit 18d up to an ejection port 34. While this transport path 32 is located in the vicinity of a rear surface (namely, left side surface viewed in FIG. 1) of the image forming apparatus main body 12, this transport path 32 owns such a portion which is formed along the substantially vertical direction from the feed roller 30 of the lowermost paper supply unit 18d up to a fixing apparatus 36 (will be discussed later) . Both a transfer apparatus 42 (will be explained later) and an image carrier 44 (will be explained later) are arranged on an upper stream side of the fixing apparatus 36 of this transport path 32. Furthermore, a register roller 38 is arranged on an upper stream side of both the transfer apparatus 42 and the image carrier 44. In addition, an ejection roller 40 is arranged in the vicinity of an ejection port 34 of the transport path 32.

As a result, the recording mediums which are fed out from the paper supply cassettes 22 of the paper supply units 18a to l8d by the paper supply roller 24 are smoothly separated by the retard roller 26 and the nudge roller 28 to be conducted to the transport path 32, and then, are temporarily stopped by the register roller 38. After proper timing is controlled, a developed image is transferred to the recording medium while the recording medium is penetrated between the transfer apparatus 42 and the image carrier 44 (will be explained later), and this transferred developed image is fixed on the fixing apparatus 36, and then, the recording medium on which the fixed image has been formed is ejected from the ejection port 34 to the ejection unit 16 by the ejection roller 40,

It should be noted that when a double-surface printing mode is carried out, this recording medium is returned to an inversion path 48. In other words, a front path portion of the transport path 30 as to the ejection roller 40 is separated into two paths, a switching craw 46 is provided at this separated path portion, and the inversion path 48 is formed from this separated path portion up to the register roller 38. While transport rollers 50a to 50c are provided in this inversion path 48, in the case of the double-surface printing mode, the switching claw 46 is switched to such a side that the inverted at a time instant when a front edge portion of a recording medium is engaged with the ejection roller 40, so that this recording medium is conducted to the inversion path 48, and then, is penetrated through the register roller 38, the transfer apparatus 42, the image carrier 44, and the fixing apparatus 36 so as to be ejected from the ejection port 34 to the ejection unit 16.

The ejection unit 16 owns an inclination portion 52 which is freely pivotable with respect to the image forming apparatus main body 12. This inclination portion 52 is inclined in such a manner that an ejection port portion thereof is low and is gradually heightened toward a front surface direction (namely, right direction viewed in FIG. 1). This ejection port portion is used as a lower end of the inclination portion 52 and a tip portion which is heightened is used as an upper end thereof. This inclination portion 52 is supported with respect to the image forming apparatus main body 12 in such a manner that this inclination portion 52 is freely pivotable, while the lower end thereof is located at a center. As indicated by a two-dot/dash line in FIG. 1, when this inclination portion 52 is rotated toward the upper direction so as to be opened, an opening unit 54 is formed, and a process cartridge (will be explained later) 64 can be detachably mounted via this opening unit 54.

The image forming section 14 is made of, for instance, an electro-photographic type image forming unit. This image forming section 14 is arranged by the image carrier 44 constructed of a photosensitive material, a charging apparatus 56, an optical writing apparatus 58, a developing apparatus 60, a transfer apparatus 42, a cleaning apparatus 62, and a fixing apparatus 36. The charging apparatus 56 is constituted by, for example, a charge roller capable of uniformly charging the image carrier 44. The optical writing apparatus 58 writes a latent image in an optical manner on the image carrier 44 charged by the charging apparatus 56. The developing apparatus 60 develops the latent image of the image carrier 44, which has been formed by the optical writing apparatus 58, by way of developer so as to produce a visible image. The transfer apparatus 42 is constituted by, for example, a transfer roller which transfers the developed image by the developing apparatus 60 to paper. The cleaning apparatus 62 is constituted by, for instance, a blade which cleans the developer left on the image carrier 44. The fixing apparatus 36 is arranged by both a pressure-applying roller and a heating roller, by which the developed image which has been transferred onto the paper by the transfer apparatus 42 is fixed on this paper. The optical writing apparatus 58 is constructed of, for example, a scanning type laser exposing apparatus, and is arranged in parallel to the paper supply units 18a to 18d, and is located in the vicinity of a front surface of the image forming apparatus main body 12. As will be explained later, the optical writing apparatus 58 exposes the image carrier 44 by scanning light beams across the inner space of the developing apparatus 60. This exposing position of the image carrier 44 may constitute a latent image writing position “P.” It should be noted that in this embodiment mode, the scanning type laser exposing apparatus has been employed as the optical writing apparatus 58. Alternatively, an LED (Light Emitting Diode), a surface emitting laser, and the like may be employed.

The process cartridge 64 is arranged by employing the image carrier 44, the charging apparatus 54, the developing apparatus 60, and the cleaning apparatus 62 in an integral body. This process cartridge 64 is arranged just under the inclination portion 52 of the ejection unit 16, and as previously explained, is detachably mounted via the opening portion 54 which is formed when the inclination portion 52 is opened.

This process cartridge 64 is detachably separated into an image carrier unit 66 and a developing apparatus unit 68. In the image carrier unit 66, the image carrier 44, the charging apparatus 54, and the cleaning apparatus 62 are arranged. In the developing apparatus unit 68, the developing apparatus 60 is arranged. The developing apparatus unit 68 owns a developer storage space 70 which stores thereinto, for example, developer. An upper portion of this developer storage unit 70 belongs to such an area “A” which is surrounded by the inclination portion 52, a horizontal plane extended from the lower end of the inclination portion 52, and also, a vertical plane extended from the upper end of this inclination portion 52 as indicated by a two-dot/dash line in FIG. 1. Also, an upper wall plane 72 which constitutes the developer storage space 70 is formed in such a manner that this upper wall plane 72 is located in parallel to the inclination portion 52 and along this inclination portion 52. Also, a plurality of ribs 74 are formed on a lower surface of the inclination portion 52 in such a way that these plural ribs 74 are positioned in parallel to each other along the inclination direction of the inclination portion 52. Since these ribs 74 are formed, a flow path 76 is formed between the inclination portion 52 and the process cartridge 64. This flow path 76 is employed so as to penetrate air therethrough, and this flow path 76 may disperse heat produced from the fixing apparatus 36. Furthermore, a grip portion 78 is formed on the upper portion of the developer storage space 70. This grip portion 78 is formed in such a manner that wall surfaces of both sides of the upper portion of the developer storage space 70 are entered into the inside thereof. When the process cartridge 64 is detachably mounted, this process cartridge 64 can be readily detachably mounted by gripping this grip portion 78.

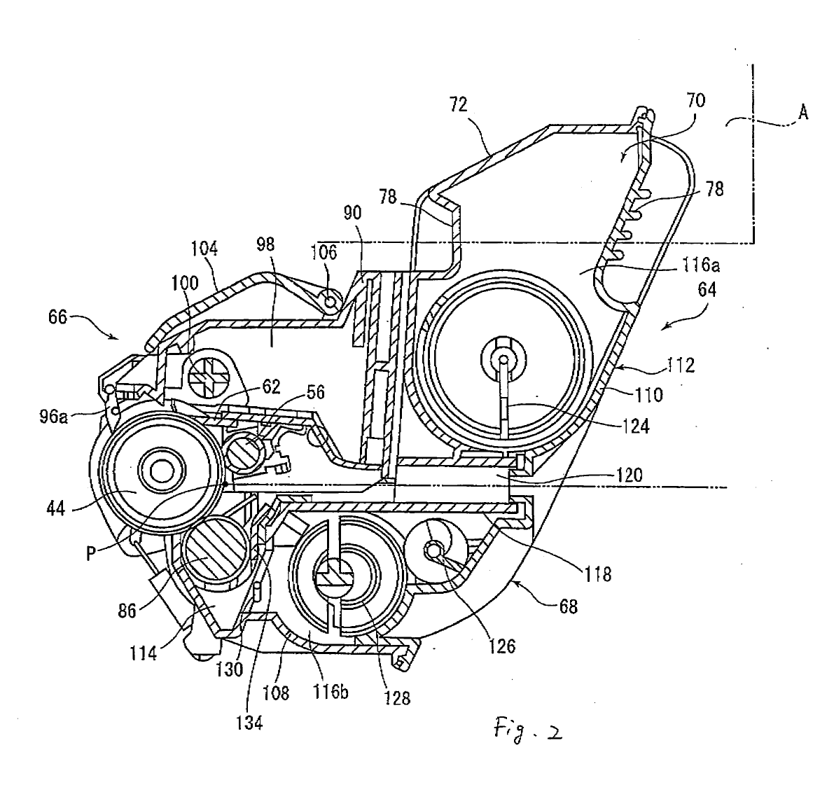

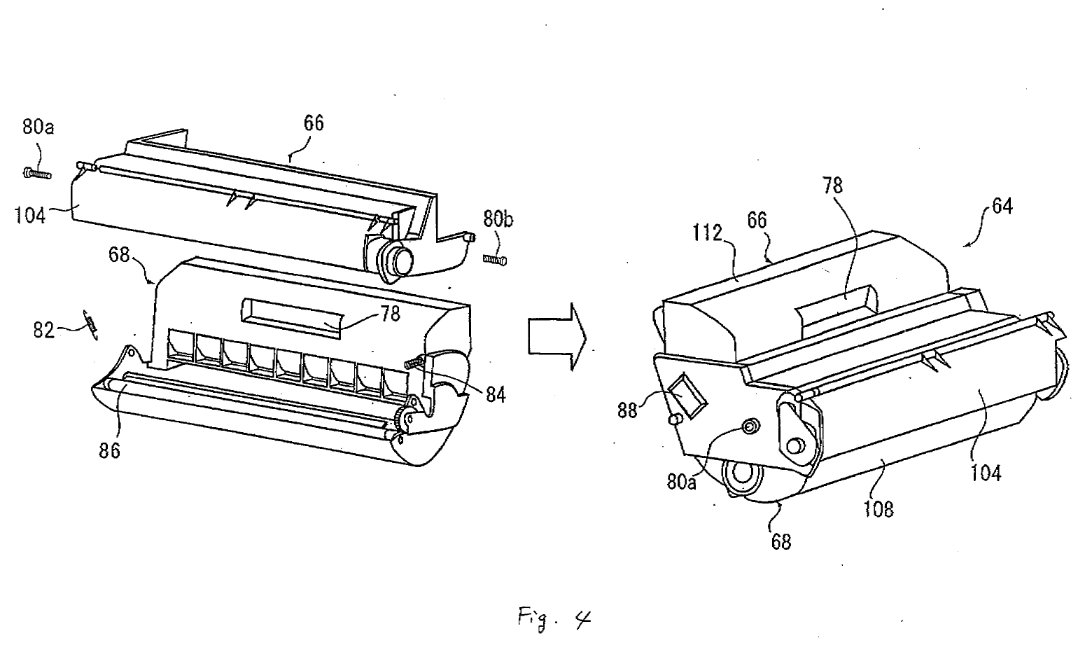

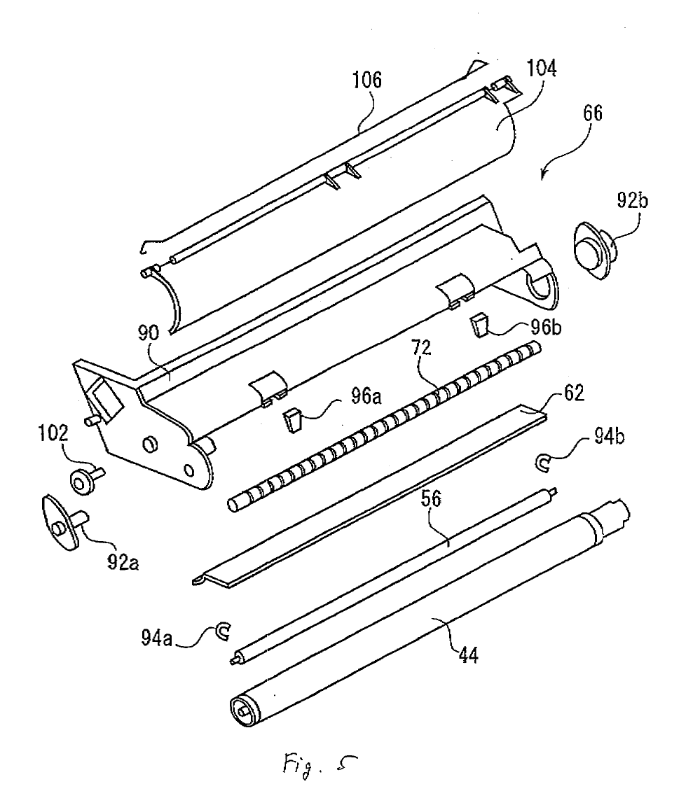

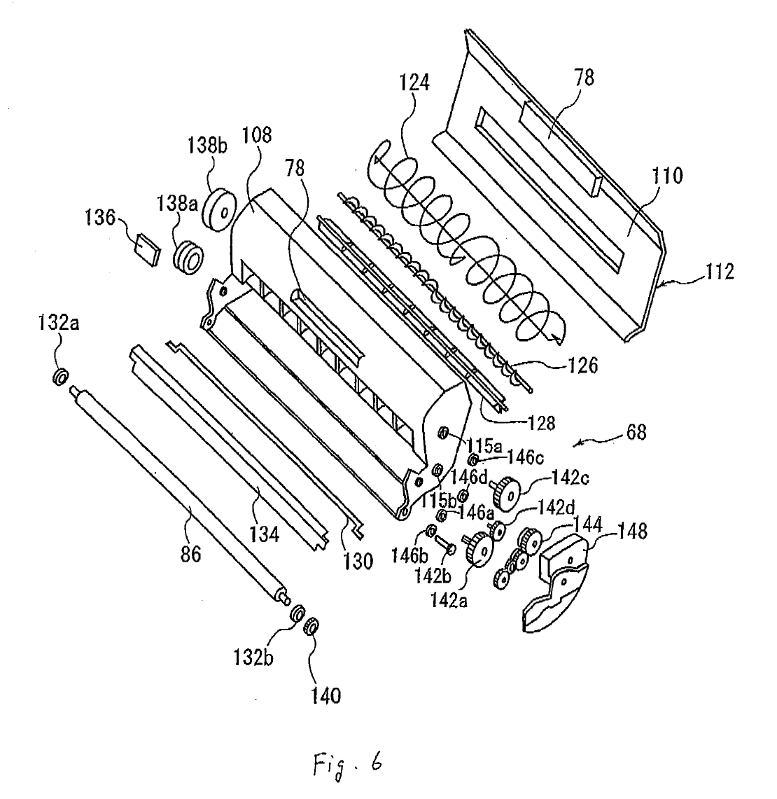

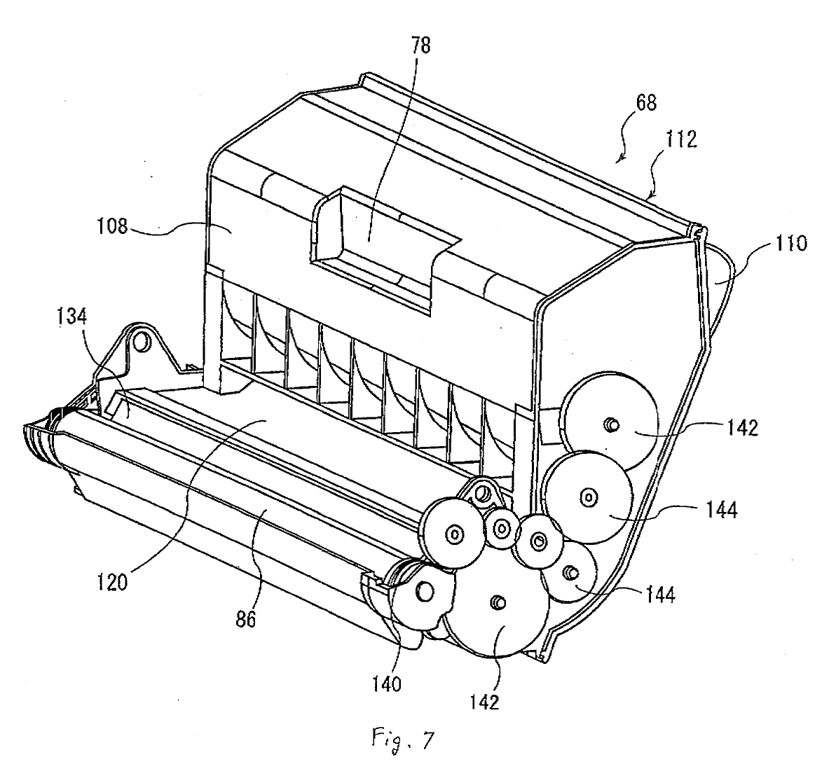

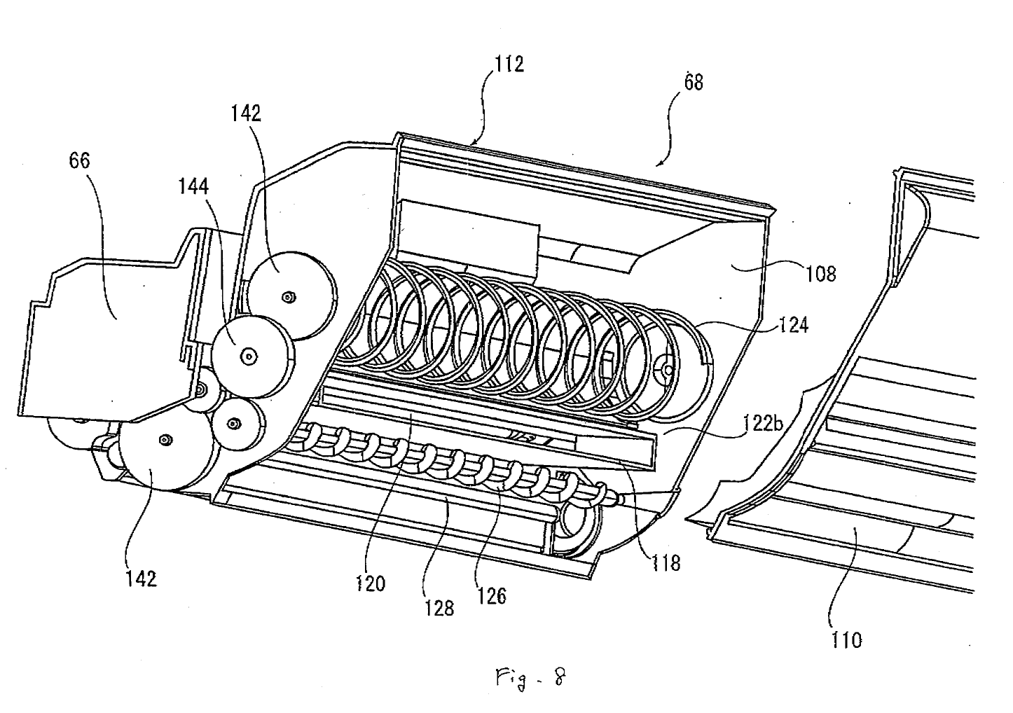

In FIG. 2 to FIG. 8, a detailed construction of the process cartridge 64 is indicated. As explained above, the process cartridge 64 is arranged by the image carrier unit 66 and the developing apparatus unit 68, and this image carrier unit 66 is coupled to the developing apparatus unit 68 via coupling pins 80a and 80b in such a manner that this image carrier unit 66 is freely pivotable with respect to the developing apparatus unit 68. Also, both the image carrier unit 66 and the developing apparatus 68 are energized with each other by a tension spring 82 and a depression spring 84, and a developing roller 86 is depressed against the image carrier 44.

It should also be understood that a memory 88 for storing thereinto a total print number and the like is provided on a side surface of the process cartridge 64 (namely, side surface of one, or both image carrier unit 66 and developing apparatus unit 68).

The image carrier unit 66 owns a main body 90 of the image carrier unit 66, and both the image carrier 44 and the charging apparatus 56 are supported by this image carrier unit main body 90 in such a manner that both the image carrier 44 and the charging apparatus 56 are rotatably supported by this image carrier unit main body 90 via bearing 92a and 93b used for the image carrier 44, and bearings 94a and 94b used for the charging apparatus 56, respectively. The bearing 94a and bearing 94b for the charging apparatus 56 own another function of a power supply portion. Also, for example, two fingers 96a and 96b are supported by the image carrier unit main body 90 in such a manner that these fingers 96a and 96b are freely pivotable with respect to this image carrier unit main body 90. Since tip portions of these fingers 96a and 96b are depressed by a spring for the fingers 96a and 96b on the surface of the image carrier 44, a recording medium which will wrap the image carrier 44 is stripped by these tip portions. Also, a developer collecting space 98 is formed the cleaning apparatus (cleaning blade) 62 within the image carrier unit main body 90, and thus, developer which has been scratched/dropped by the cleaning apparatus 62 is collected into this developer collecting space 98. A paddle 100 is rotatably provided in this developer collecting space 98. This paddle 100 is supported via a gear 102 for the paddle 100 by the image carrier unit main body 90, and transports the developer which has been collected by being rotated to an inner side of the developer collecting space 98. Also, a shutter 104 is provided at the upper portion of the image carrier unit main body 90 in such a manner that this shutter 104 can be freely opened/closed. This shutter 104 is supported via a shaft 106 for the shutter 104 with respect to the image carrier unit main body 90 in a freely movable manner. This shutter 104 closes an opening portion of the image carrier 44 before the process cartridge 64 is mounted, and is opened in order that the image carrier 44 is come out to the front in the case that the process cartridge 64 is mounted.

The developing apparatus unit 68 contains a main body 112 of the developing apparatus unit 68 which is constituted by jointing a front housing 108 to a rear housing 110. An inner space of this developing apparatus unit main body 112 is segmented into the developer collecting space 70 and a developing unit 114 in which. the developing roller 86 is arranged. The developer collecting space 70 is separated into a first developer storage portion 116a and a second developer storage portion 116b via a partition wall 118, while a horizontal line extended from the latent image writing position “P” is defined as a boundary. This horizontal line corresponds to a scanning optical path originated from the optical writing apparatus 58. The first developer collecting portion 116a is located at an upper portion of the developer storage portion 116b is located at a lower portion thereof. A developer storage capacity of the first developer storage unit 116a is made larger than a developer storage capacity of the second developer storage unit 11b.

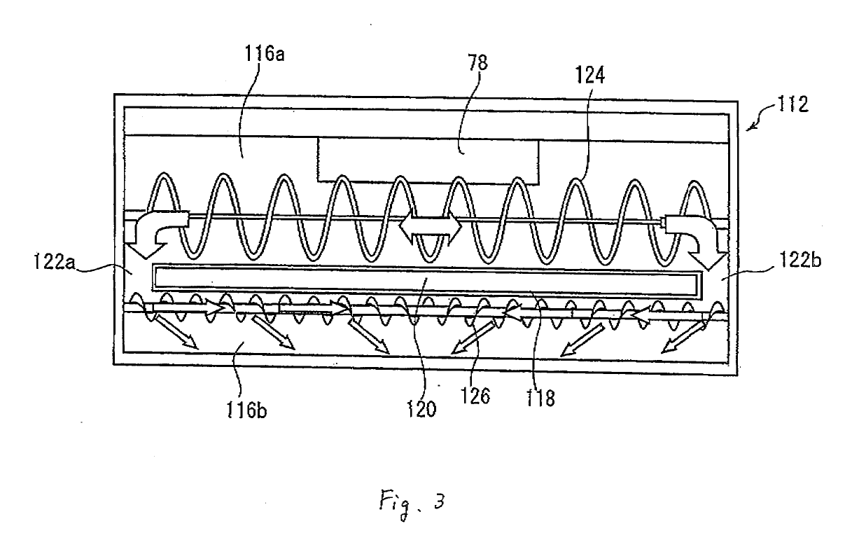

As shown in FIG. 3, the partition wall 118 constitutes a window portion 120 having, for example, a rectangular shape, which forms the optical scanning path defined from the optical writing apparatus 58. Also, this partition wall 118 constitutes developer paths 122a and 122b in connection with the developing apparatus unit main body 112 on both sides of this window portion 120. Both the developer paths 122a and 122b cause the first developer storage portion 116a to be communicated with the second developer storage portion 116b. In the first developer storage portion 116a, as previously explained, an upper portion of this first developer storage portion 116b is arranged within the area “A”, and also, a first stirring/transporting member 124 is rotatably arranged. This first stirring/transporting member 124 is constituted by such a wire member which is formed in a helical shape along different winding directions to each other. The first stirring/transporting member 124 supplies the developer stored in the first developer storage port 116a to the developer paths 122a and 122b. A second stirring/transporting member 126 is rotatably arranged at a lower position -of the first stirring/transporting member 124 within the second developer storage unit 116b. This second stirring/transporting member 126 is constituted by a screw shaft formed along different direction from edge portions thereof (viewed along axial direction) toward a center portion thereof. Since the developer is uniformly dispersed by the second stirring/transporting member 124, the developer supplied from the developer paths 122a and 122b formed on the both sides may be transported along the center direction. As a consequence, as indicated by an arrow of FIG. 3, the developer which has been stored in the first developer storage unit 116a is transported to the both sides of the first stirring/transporting member 124 by this first stirring/transporting member 124, and then, is dropped via the developer paths 122a and 122b to the second developer storage unit 116b, and thereafter is uniformly dispersed by rotating the second stirring/transporting member 124, so that the dispersed developer is transported to the side of the developing roller 86.

Furthermore, both a third stirring/transporting member 128 and a fourth stirring/transporting member 130 are arranged in the second developer storage portion 116b. The third stirring/transporting member 128 transports the developer transported by the second stirring/transporting member 126 to the fourth stirring/transporting member 130. This fourth stirring/transporting member 130 is arranged at an output port of the second developing member storage portion 116b. The fourth stirring/transporting member 130 transports the developer which has been transported by the third stirring/transporting member 128 to the developing roller 86, and also, mixes this new developer with the deteriorated developer which has been scratched/dripped from the developing roller 86.

As is well known in the field, the developing roller 86 is constructed in such a manner that a sleeve is wound on a magnet roller, and tracking caps 132a and 132b are provided on both sides of the magnet roller. These tracking caps 132a and 132b are made in contact to the image carrier 44, and as explained in the above description, a developing gap may be secured by depressing these tracking caps 132a and 132b against the image carrier 44 by both the tension spring 82 and the depression spring 84. A layer thickness restricting member 134 made of, for instance, a resin is made in contact with the developing roller 86. A thickness of a developer layer adhered on the surface of the developing roller 86 is restricted by this layer thickness restricting member 134. Also, a side surface of this developing roller 86 is sealed by a developing portion sealing member 136.

It should also be noted that reference numerals 138a and 138b indicate developer caps which are detachably mounted on the developing apparatus unit main body 112. Since these developer caps 138a and 138b are pulled out, the developer is supplied to either the first developer storage unit 116a, or the second developer storage unit 116b.

In the drive system of the process cartridge 64, drive force is transferred from the side of the image carrier 44, and then, is transferred via a developing roller gear 140, a gear 142 for the respective first to fourth stirring/transporting members, and an idle gear 144 to the developing roller 86 and also to the respective first to fourth stirring/transporting members 124 to 130. A stirring/transporting member sealing member 146 is inserted into a bearing portion of the stirring/transporting member gear 146. Furthermore, a gear cover 148 is provided on the side surface of the developing apparatus unit main body 112, while this gear cover 148 covers the gear 142 for the respective stirring/transporting members and the idle gear 144.

Next, operations of the image forming apparatus according to the embodiment mode will now be described.

While the image carrier 44 is uniformly charged by the charging apparatus 56, light emitted from the optical writing apparatus 58 is irradiated onto this charged image carrier 44 in response to an image signal, and then, a latent image is formed at the latent image forming position “P” thereof. The light emitted from the optical writing apparatus 58 passes through the process cartridge 64 via the window portion 120 of the process cartridge 64. The latent image which has been formed on the image carrier 44 by this optical writing apparatus 58 is developed by the developer of the developing apparatus 60 so as to produce a visible image.

While the developer has been stored in both the first developer storage portion 116a and the second developer storage portion 116b, the developer stored in the first developer storage portion 116a is transported to both sides by rotating the first stirring/transporting member 124, and then both the developer located on the both sides is transported via the two developer paths 122a and 122b to the second developer storage unit 116. Furthermore, the developer of the second developer storage portion 116b is uniformly dispersed by rotating the second stirring/transporting member 126, and then, the uniformly dispersed developer is transported to the developing unit 114 by the third stirring/transporting member 128 and the fourth stirring/transporting member 130. In this developing unit 114, the transported developer is adhered onto the developing roller 86, the layer thickness of the adhered developer is restricted by the layer thickness restricting member 134, the thickness restricted developer is transported up to a developing position located opposite to the image carrier 44, and then, an image made of the developer is formed in correspondence with the latent image of the image carrier 44.

On the other hand, one of the paper supply units 18a to 18d is selected in response to a size signal and the like, recording mediums stored in one of these paper supply cassettes 22 are fed out by the paper supply roller 24, and these recording mediums are smoothly separated by the retard roller 26 and the nudger roller 28 so as to conduct a recording medium to the transport path 32. Then, this conducted recording medium is temporarily stopped by the register roller 38, and thereafter, this recording medium is conducted between the transfer apparatus 42 and the image carrier 44 at proper timing.

When the recording medium is conducted between the transfer apparatus 42 and the image carrier 44 in this manner, the developer on the image carrier 44 is transferred to the recording medium by the transfer apparatus 42. This recording medium to which the developer has been transferred is penetrated through the fixing apparatus 36, and then is ejected from the ejection port 34 to the ejection unit 16.

The recording medium is penetrated through the transport path 32, and then is ejected to the ejection unit 16, and thus a so-called “C-path” is constituted, while this transport path 32 is formed along the substantially vertical direction from the paper supply units 18a to 18d arranged along the horizontal direction. In this embodiment mode, since the process cartridge 64 is stored within the C-path, the layout of this image forming apparatus can be made compact. However, if the developer storage space connected to the developing unit 114 is arranged lower than the latent image writing position “P” in the normal design manner, such a dead space is produced under the ejection portion 16. More specifically, in the case that a storage capacity of the developer is increased, since the space located lower than the latent image writing position “P” must be increased, a larger dead space is produced.

However, in this embodiment mode, the window portion 120 which constitutes the scanning optical path from the optical writing apparatus 58 is formed in the process cartridge 64, and the developer paths 122a and 123b are formed on both sides of this window portion 120, and also the first developer storage portion 116a can be arranged above the scanning optical path. Further, a portion of the first developer storage unit 116a is located within the area “A” which is surrounded by the inclination portion 52, the horizontal plane extended from the lower end of the inclination portion 52, and also the vertical plane extended from the upper end of the inclination portion 52. As a result, the lower portion of the ejection unit 16 can be effectively utilized as the developer storage portion.

In the embodiment modes, the one-component developing system is employed. The present invention is not limited to this one-component developing system, but may be applied to a two-component developing system. Also, in the embodiment mode, the developed image is directly transferred from the image carrier to the recording medium. However, the present invention is not limited to this transfer operation, but may be applied to another embodiment in which an intermediate transfer member may be interposed between the image carrier and the recording medium. Furthermore, in the embodiment modes, the black/white image forming apparatus has been described. Apparently, the present invention may be applied to a color image forming apparatus. In this case, for instance, assuming now that four developing apparatus are employed, if a developer storage space of at least one developing apparatus is arranged under the ejection unit, then the dead space problem may be sufficiently solved.

As previously described, in accordance with the present invention, since the lower portion of the ejection unit is used as the developer storage space, this lower portion where the dead space is readily produced can be effectively utilized. As a consequence, the compact image forming apparatus can be provided.

What is claimd is:

1. An image forming apparatus comprising:
an image forming section having a developer storage space into which developer is stored; and
an ejection unit for ejecting therefrom a recording medium on which an image has been formed by the image forming section, wherein
the ejection unit owns an inclination portion which has a lower end and an upper end, while being obliquely formed, and
at least a portion of the developer storage space of the image forming section is arranged in an area which is surrounded by the inclination portion, a horizontal plane extended from the lower end of the inclination portion, and a vertical plane extended from the upper end of the inclination portion.

2. An image forming apparatus comprising:
an image forming section having a developer storage space into which developer is stored; and
an ejection unit for ejecting therefrom a recording medium on which an image is formed by the image forming section, wherein
the ejection unit owns an inclination portion which is obliquely formed, and
at least a portion of a wall surface which surrounds the developer storage space along the inclination portion is formed.

3. The image forming apparatus according to claim 1, wherein
the image forming section includes an image carrier, an optical writing apparatus for forming a latent image on the image carrier, and a developing apparatus containing the developer storage space, for developing the latent image of the image carrier so as to produce a visible image,
the developer storage space owns a first developer storage portion arranged at an upper portion thereof, and a second developer storage portion arranged at a lower portion thereof, while sandwiching therebetween a horizontal line which is extended from a latent image forming position of the image carrier by the optical writing apparatus along a horizontal direction, and
the first developer storage portion is connected to the second developer storage portion.

4. The image forming apparatus according to claim 3, wherein
a developer storage capacity of the first developer storage portion is larger than that of the second developer storage portion.

5. The image forming apparatus according to claim 4, wherein
the optical writing apparatus is constituted by a laser exposing apparatus, and is arranged at a position which is extended from the latent image forming position of the image carrier to the horizontal direction.

6. The image forming apparatus according to claim 1, wherein
the image forming section includes a process cartridge which includes an image carrier on which a latent image is formed, and a developing unit containing the developer storage, for developing the latent image of the image carrier so as to produce a visible image.

7. The image forming apparatus according to claim 6, wherein
the inclination portion can be freely opened/closed, and the process cartridge can be detachably mounted via an opening portion which is formed when the inclination portion is opened.

8. The image forming apparatus according to claim 6 further comprising:
a paper supplying apparatus having a supply unit for supplying the recording medium;
a transfer apparatus provided opposite to the image carrier of the process cartridge;
a fixing apparatus arranged on the down-stream side of the transfer apparatus; and
a transport path for transporting the recording medium supplied from the supply unit of the paper supplying apparatus between the image carrier and the transfer apparatus, and for ejecting the recording medium via the fixing apparatus to the ejection unit, wherein
a portion of the transport path defined from the supply unit of the paper supply apparatus up to the fixing apparatus is formed along a substantially vertical direction.

9. The image forming apparatus according to claim 1, wherein
the inclination portion of the ejection unit has the lower end in the vicinity of an exit port from which the recording medium is ejected, and is heightened toward the upper end of the inclination portion.

10. The image forming apparatus according to claim 6, wherein
a grip portion is provided on the wall surface which surrounds the developer storage space.

11. The image forming apparatus according to claim 10, wherein
the grip portion is formed in such a manner that the grip portion is entered into an inner side of a wall surface of the grip portion.

12. The image forming apparatus according to claim 2, wherein
a flow path for causing air to pass therethrough is formed between the ejection portion and the wall surface.

13. The image forming apparatus according to claim 12, wherein
the flow path is constructed of a rib which is formed on at least one of the ejection unit and the wall surface.

14. The image forming apparatus according to claim 13, wherein
the rib is formed along an ejection direction of the recording medium which is ejected to the ejection unit.

15. A process cartridge used in an image forming apparatus containing an ejection unit having an inclination portion which is obliquely formed in order to eject therefrom a recording medium comprising; a developer storage space for storing thereinto developer, wherein
at least a portion of the developer storage space is arranged in a space which is surrounded by the inclination portion, a horizontal plane extended from a lower end of the inclination portion, and also, a vertical plane extended from an upper end of the inclination portion.

16. A process cartridge used in an image forming apparatus containing an ejection unit having an inclination portion which is obliquely formed in order to eject therefrom a recording medium comprising:
a developer storage space for storing thereinto developer, wherein
at least a portion of a wall surface which surrounds the developer storage space is formed along the inclination portion.
